(19) United States
(12) Patent Application Publication
(10) Pub. No.: US 2009/0293277 A1
(43) Pub. Date: Dec. 3, 2009

(54) PROCESS FOR MANUFACTURING LAMINATED STRUCTURE AND PROCESS FOR MANUFACTURING INKJET RECORDING HEAD

(75) Inventor: Hiroki UCHIYAMA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/473,384

(22) Filed: May 28, 2009

(30) Foreign Application Priority Data
Jun. 3, 2008 (JP) 2008-146113

(51) Int. Cl. B23P 17/00

(52) U.S. Cl. 29/890.1

(57) ABSTRACT

A laminated structure 400 in which plural members 410, 420, 430, 440, 450, 460, 470 are laminated via crosslinking resins 415, 465 at a part thereof is provided, a high pressure fluid 315 is supplied to a part of the laminated structure on which a crosslinking resin is exposed, whereby the crosslinking degree of the crosslinking resin is increased and, thereafter, the high pressure fluid is removed from the laminated structure. In the case of an inkjet recording head, after removal of the high pressure fluid, a plating film 423 is further formed on an inner wall 422 of an ink flow path 490, with a mixed fluid 317 obtained by mixing and stirring a second high pressure fluid and a plating solution.

### CROSS REFERENCE TO RELATED APPLICATION

This application claims priority under 35USC 119 from Japanese Patent Application No. 2008-146113, the disclosure of which is incorporated herein by reference.

### BACKGROUND OF THE INVENTION

1. Field of the Invention

The present invention relates to a process for manufacturing a laminated structure using a high pressure fluid such as a supercritical fluid, and a process for manufacturing an inkjet recording head.

2. Description of the Related Art

Previously, in development of an inkjet recording head, in order to prevent corrosion of a member (head member) constituting a head due to contact with an ink, it is one of indispensable conditions to select a member having ink resistance, and form a protective film at a part with which the ink contacts.

In recent years, the inkjet recording heads constructed by laminating plural members has been increased. However, when the head is constructed of members having ink resistance, a degree of freedom of selecting head members is narrowed. Particularly, when a number of members are laminated to construct a head, it is difficult to select a member having ink resistance while selection is adapted to the use purpose, with respect to all members.

In addition, since the head is constructed by laminating plural members, connection deficiency arises at a joint of members to be laminated, in some cases. For example, reduction in the adhesion strength, and peeling are easily caused, such as by insufficient ink resistance at a joint of an adhesive and inclusion of air bubbles in an interface between the member and the adhesive at the time of the adhesion.

As a method of imparting ink resistance to every head member, for example, there is a method for forming a corrosion-resistant protective film of SiO₂ on a surface of each member in advance and, thereafter, connecting the members to each other. However, in such a method, since the protective film is formed for every member, the number of steps is increased, and a process is complicated, and improvement in the adhesive strength and ink resistance at a joint may not be realized.

On the other hand, there is a method of forming an inkjet recording head from one member, or by laminating thin plate-like members, and then forming a protective film having ink resistance such as a plating film, at a part with which an ink contacts, particularly, on an inner wall of an ink flow path (see e.g. Japanese Patent Application Laid Open (JP-A) No. 8-187867, and JP-A No. 2006-76267).

In this case, even when the member itself forming a head is inferior in ink corrosion resistance, since the ink flow path is coated with a corrosion-resistant protective film, a problem of ink resistance is overcome and, at the same time, increase in steps may be suppressed. And, when the interior of the ink flow path is coated with a protective layer (corrosion-resistant layer) after connection of members, the effect of preventing a void, a crack, and leakage of the ink at a joint is also obtained.

However, even when the protective film is formed in the ink flow path, since an adhesive force between members at the joint is greatly influenced by an adhesive force of an adhesive itself, the adhesive strength may not be sufficiently improved, in some cases.

In addition, when the protective film is formed on a fine structure by a plating method, the viscosity and the surface tension of a plating solution are problematic and, additionally, occurrence of a defect such as a nodule (node-like deposition), a pinhole, and a void generated in a plating film is problematic. For this reason, it is difficult to form a uniform and conformal protective film on an internal surface of a fine and complicated flow path and nozzle in an inkjet head or the like.

In addition, when thin-plate members are laminated to construct an ink jet recording head, one of causes for occurrence of connection deficiency between members is air bubbles included in an interface between a head member and an adhesive at the time of the adhesion, as described above. Such an inclusion of air bubbles in an adhesive or an adhesion interface leads to not only reduction in the adhesion strength but also invasion of the ink into the interior of the adhesive and the adhesion interface, which becomes a cause for occurrence of insufficient connection.

In order to prevent air bubbles from remaining in an adhesive, a method of reducing air bubbles remaining in the adhesive by pre-heating head members and the adhesive, coating the adhesive on the head members, thereafter, putting the members in the vacuum atmosphere to connect them, then, under the atmospheric pressure, pressurizing the members to each other in a connection direction and raising a temperature to decrease the thickness of the adhesive, is proposed (see JP-A No. 9-123466).

However, since such a method leads to increase in the man-hour, and complication, and there is a part which may not be sufficiently pressurized upon connection due to a structure of the inkjet recording head having an ink flow path in the interior thereof, a problem of reduction in the strength of the inkjet recording head, and pressure leakage at the time of jetting ink is easily caused by defective connection at the relevant part. In addition, there is also a problem in that treatment in the vacuum atmosphere, and pressurization in a connection direction using an adhesion jig adversely influence on each head member, and protrusion of the adhesive from between members easily generates so-called a burr. In addition, even if remaining of air bubbles may be reduced by thinning the adhesive, there is a problem in that ink resistance at a joint is not maintained.

As described above, when plural members are laminated to manufacture an inkjet recording head, previously, a method of maintaining ink resistance in an ink flow path, and a method of improving the adhesion strength have been proposed. However, it is necessary to adopt entirely different methods, and there is a problem in that a conformal protective film is formed with difficulty, and a process is complicated.

When a laminated structure having a fine structure, such as not only the inkjet recording head but also a microdevice, is manufactured by laminating plural members, defective connection between the members easily influences on performance greatly.

### SUMMARY OF THE INVENTION

The present invention has been made in view of the above circumstances and provides the following process for manufacturing a laminated structure and a process for manufacturing an inkjet recording head.

According to a first aspect of the invention, a process for manufacturing a laminated structure including: providing a laminated structure in which plural members are laminated via a crosslinking resin at a part thereof, supplying a high pressure fluid to a part of the laminated structure on which the crosslinking resin is exposed, thereby, increasing the crosslinking degree of the crosslinking resin, and removing the high pressure fluid from the laminated structure is provided.

According to a second aspect of the invention, a process for manufacturing an inkjet recording head including: providing a laminated structure for an inkjet recording head having an ink flow path, in which plural members are laminated via a crosslinking resin at a part thereof, supplying a first high pressure fluid to the ink flow path of the laminated structure, thereby, increasing the crosslinking degree of the crosslinking resin which is exposed in the ink flow path, removing the first high pressure fluid from the ink flow path, and forming a plating film on an inner wall of the ink flow path with a mixed fluid obtained by mixing and stirring a second high pressure fluid and a plating solution, after the high pressure fluid removal, is provided.

### BRIEF DESCRIPTION OF THE DRAWINGS

FIG. 1A is a schematic view showing one example of supplying a high pressure fluid to a resin layer of a laminated structure to increase a crosslinking degree.

FIG. 1B is a schematic view showing another example of supplying a high pressure fluid to a resin layer of a laminated structure to increase a crosslinking degree.

FIG. 2 is a state diagram showing a supercritical fluid and a sub-critical region.

FIG. 3 is a view showing one example of steps upon manufacturing of an inkjet recording head by the invention.

FIG. 4 is a schematic view showing a laminated structure in each step from a crosslinking degree increasing step to a plating step.

FIG. 5 is a schematic view showing one example of a structure of a supercritical fluid apparatus which may be used in the invention.

FIG. 6 is a schematic view showing a state of a high pressure fluid and a plating solution in electroless plating.

FIG. 7A is a schematic view showing before formation of a plating film between members having vacant gaps.

FIG. 7B is a schematic view showing after formation of a plating film between members having vacant gaps.

FIG. 8 is a schematic view showing one example of plating by electroplating.

### DETAILED DESCRIPTION OF THE INVENTION

The present invention will be specifically explained below by referring to attached drawings. Drawings merely schematically show the shape, size and arrangement relationship of respective components to such an extent that the invention may be understood, and the invention is not particularly limited by them.

The process for manufacturing a laminated structure according to the invention includes: providing a laminated structure in which plural members are laminated via a crosslinking resin at a part thereof, supplying a high pressure fluid to a part on which the crosslinking resin is exposed, thereby, increasing a crosslinking degree of the crosslinking resin, and removing the high pressure fluid from the laminated structure.

### <Laminated Structure>

In the invention, a laminated structure is not particularly limited as far as it is a laminated structure in which plural members are laminated via a crosslinking resin at a part thereof, but may be suitably applied to manufacturing of not only an inkjet recording head, but also a device having a fine structure such as various microdevices. Example of the microdevice include microreactors, biosensors, analysis equipments, capillary columns, and filtration filters, which are used as a means for moving a fluid in microchemistry which is being developed in many fields such as medical science, pharmaceutical science, biology, and technology. The invention may be also suitably applied to manufacturing of a device having a fine flow path, in which plural members are connected to each other via a crosslinking resin at least a part thereof.

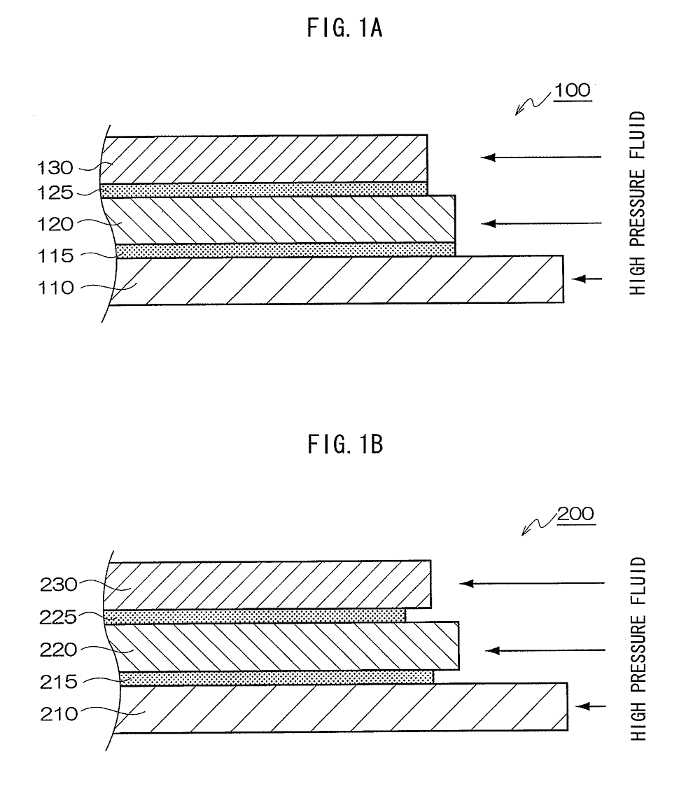

For example, as shown in FIG. 1A, a resin layer 115 containing a crosslinking resin is formed on a member 110 by the known coating method such as a spin coating, a roll coating, and a spray coating, and a member 120 is overlaid via the resin layer 115. Similarly, a resin layer 125 and a member 130 are successively overlaid in layers. Thereafter, the resin layers 115 and 125 are cured by the means such as heating, light exposure and drying depending on a material, whereby a laminated structure 100 is obtained. Respective components 110, 120 may be selected depending on the use of the laminated structure 100 and, for example, members of silicon, ceramics, a resin-based material such as a plastic, and metals may be used.

In the laminated structure 100 shown in FIG. 1A, resin layers 115, 125 are exposed, forming the same plane with edge faces of members 120, 130, respectively, but the laminated structure is not limited to such an aspect as far as resin layers are exposed between members. For example, as shown in FIG. 1B, an aspect in which concave parts are formed between members 210, 220, 230 laminated via respective resin layers 215, 225, and edge faces (exposed planes) of resin layers 215, 225 are situated in the interior of the laminated structure 200, may be adopted. In this manner, even when resin layers 215, 225 are recessed between members 210, 220, 230, since the high pressure fluid used in the invention also has a nature near that of a gas, it may easily enter a narrow place, whereby resin layers 215, 225 may be modified (increase in crosslinking degree).

<High Pressure Fluid>

The “high pressure fluid” in the invention means typically a fluid containing a supercritical fluid or a subcritical fluid.

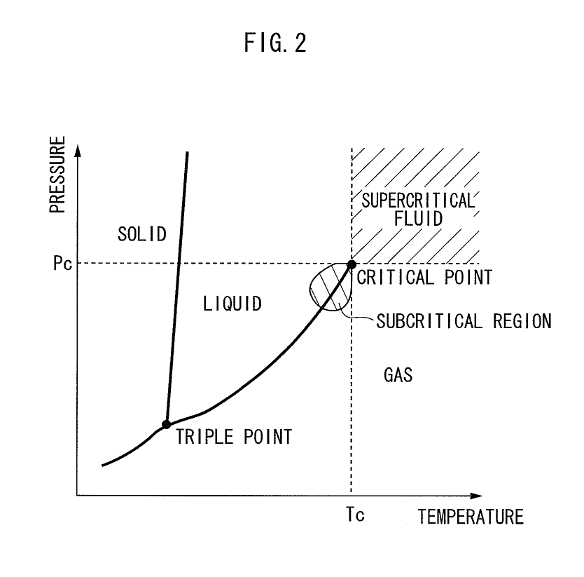

FIG. 2 is a state diagram of a pure substance. As shown in FIG. 2, the supercritical fluid is a high pressure fluid in a state where the conditions of the pressure and the temperature are P>Pc (critical pressure), and T>Tc (critical temperature) at the vicinity of a critical point. For example, in the case of carbon dioxide, the critical temperature is 304.5K, and the critical pressure is 7.387 MPa, and in a state where temperature and pressure are both greater than the critical temperature and the critical pressure, the carbon dioxide becomes a supercritical fluid (supercritical carbon dioxide).

On the other hand, the subcritical fluid refers to a fluid which is in a region in a vicinity before the critical point, and the subcritical fluid is in a state where the compressed liquid and the compressed gas coexist. A fluid in this region is distinguished from the supercritical fluid, but since the physical properties such as the density are continuously changed, there is no physical border, and the subcritical fluid in such a region may also be used as the high pressure fluid in the invention. In addition, a fluid in such a subcritical region and supercritical region near the critical point is also called a high density liquefied gas.

A kind of the high pressure fluid used in the invention is not particularly limited, but a suitable supercritical fluid or sub-critical fluid may be selected depending on a material of a resin layer of the laminated structure to be treated. Examples include carbon dioxide, oxygen, argon, krypton, xenon, ammonia, methane trifluoride, ethane, propane, butane, benzene, methyl ether, chloroform, water and ethanol. Among them, from a view point of a practical critical point, environmental suitability, and non-toxicity, a supercritical fluid of carbon dioxide is preferably used.

For the aforementioned laminated structures 100, 200, the high pressure fluid such as supercritical carbon dioxide is supplied to parts (resin layers) 115, 125, 215, 225 on which a crosslinking resin is exposed. The high pressure fluid such as a supercritical fluid exhibits a wide range of solubility in a crystal or amorphous resin. Plasticization of a resin caused by dissolution of the high pressure fluid causes change in various physical properties such as lowering of a glass transition temperature Tg, reduction in the viscosity rate, increase in the diffusion coefficient, and promotion of crystallization and, by contact of the high pressure fluid such as supercritical carbon dioxide with resin layers 115, 125, 215, 225, a crosslinking degree of the crosslinking resin contained in resin layers 115, 125, 215, and 225 is increased, whereby the adhesion strength is improved. That is, by contact of resin layers 115, 125, 215, 225 exposed between members of the laminated structure 100, 200 with the high pressure fluid such as supercritical carbon dioxide, the crosslinking degree in a resin is increased by the effect similar to that of uniform annealing, leading to increase in an adhesive force.

Then, as a suitable example, the case where, by using the high pressure fluid in the case of manufacturing an inkjet recording head, improvement in the strength of the adhesive layer, and maintenance of ink resistance in the ink flow path are continuously performed by a series of step, will be explained.

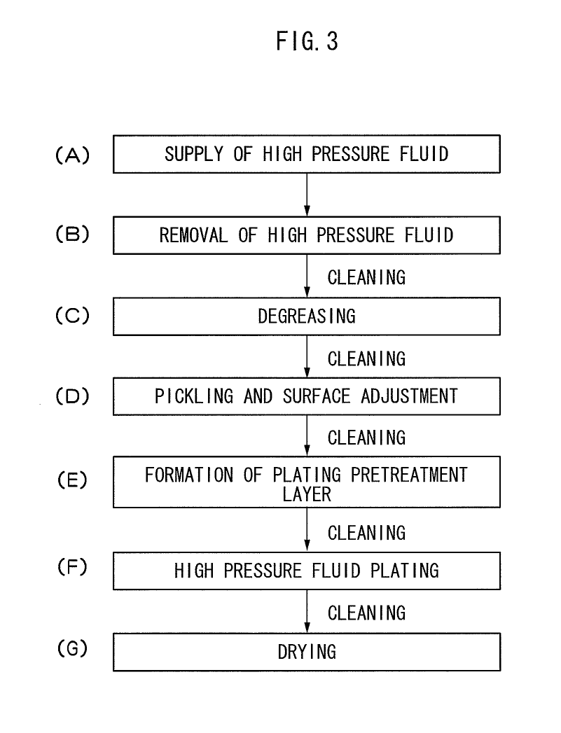

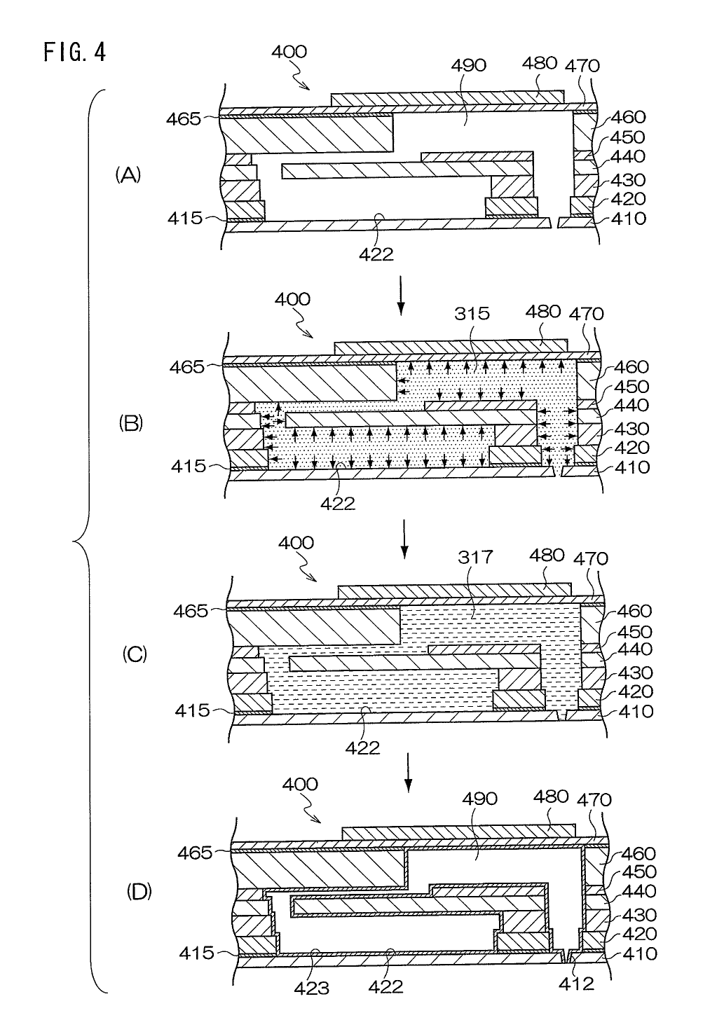

FIG. 3 is a flow sheet showing one example of the process for manufacturing the inkjet recording head according to the invention. FIG. 4 is a schematic cross-sectional view showing the state of the inkjet recording head in each step.

First, a laminated structure for an inkjet recording head having an ink flow path, in which plural members are laminated via a crosslinking resin at a part thereof, is prepared.

For example, as shown in FIG. 4 (A), by laminating plate-like members 410, 420, 430, 440, 450, 460, 470 in which a hole to be an ink flow path (channel) is formed, respectively, via crosslinking resin layers 415, 465 at a part thereof, a laminated structure 400 in which an ink flow path 490 is formed in the interior is manufactured. This laminated structure 400 has an ink flow path 490 for performing passage, storage and jet of the ink, including an ink jet nozzle 412, and an piezo-electric element 480 is adhered on an upper surface of a vibration plate 470 arranged opposite to a nozzle plate 410. The piezoelectric element 480 is connected to a driving circuit not shown, and is driven depending on an applied driving pulse. Members 410, 420, 430, 440, 450, 460, 470 constituting the laminated structure 400 may be selected depending on the purpose and, when used for the inkjet recording head, a member made of a metal, a ceramics, silicon, a glass, a resin material or the like is used.

In the laminated structure 400 shown in FIG. 4 (A), resin layers 415, 465 are provided only between a part of members (between 410 and 420, and between 460 and 470), and resin layers may be provided also between other members, depending on the necessity. For example, resin layers may be provided between all laminated members.

As resin layers 415, 465, a crosslinking resin (crosslinking adhesive), the crosslinking degree of which is increased by permeation of a high pressure fluid, is used. Examples of such a crosslinking resin include a crosslinking fluorine-containing resin, an epoxy resin, and a crosslinking silicone resin. These crosslinking resins may be used alone, or may be used by mixing two or more kinds.

In a plating step described later, a plating film is formed in the ink flow path 490 of the laminated structure 400, and when formation of a plating film on a surface of the laminated structure 400 is prevented, a protective film for plating may be formed in advance. As a material for forming a protective film for plating (protective film material), a material which is inert to a plating step, and is excellent in acid resistance and alkali resistance is preferable. Specifically, examples include a masking material for plating, a representative of which is MASK ACE (manufactured by Taiyo Chemical Co., Ltd.).

A further preferable material for a protective film is a material which does not cause a change such as foaming, swelling, peeling, and dissolution due to the high pressure fluid used in a plating step etc., which is inert to the plating step, and which is easily removed after plating. Examples include a photosensitive liquid resist having polymethylphenylsilane etc. Polymethylphenylsilane is a resist material which is hardly soluble in supercritical CO₂ used in a plating step etc., and, while after the plating step, becomes methylsiloxane by ultraviolet irradiation, and becomes soluble in supercritical CO₂. If the high pressure fluid such as supercritical CO₂ may be used upon removal of the protective film for plating, an organic solvent used at the time of resist removal as usual is unnecessary, and the amount of a waste solution generated in the step may be reduced.

A method of forming the protective film on a surface of the laminated structure 400 is not particularly limited, but a material for the protective film may be given by the known method such as a spin coating method, a roll coating method, a spray coating method, and a dipping method. After coating, by curing the material for the protective film, the protective film for plating is formed. A means for curing the material for the protective film may be selected depending on the material for the protective film used, and usually examples include heating, light exposure, and drying.

[Crosslinking Degree Increasing Step]

After the laminated structure 400 is prepared, a first high pressure fluid 315 is supplied into the ink flow path 490.

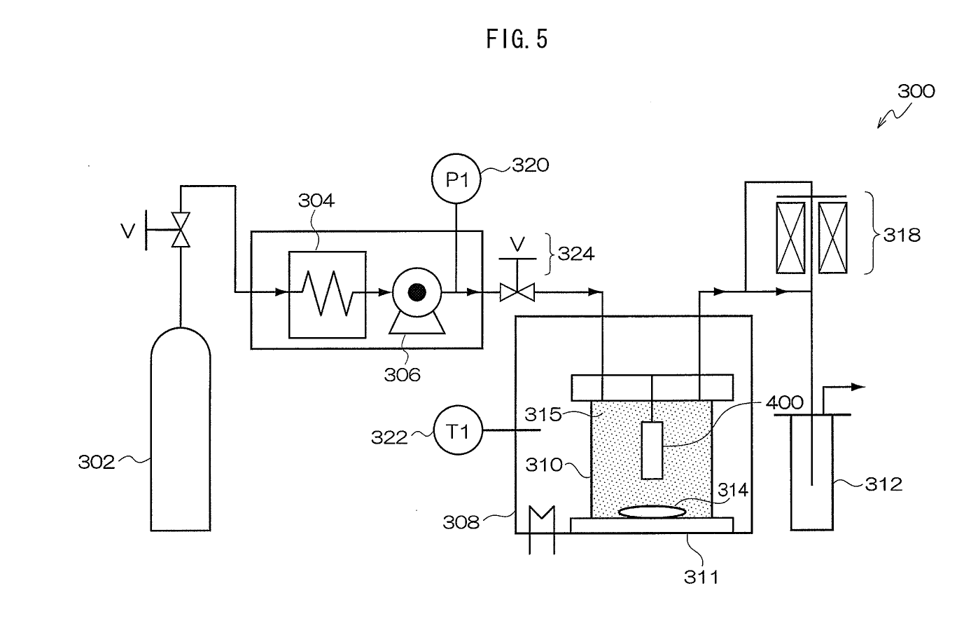

A method of supplying the first high pressure fluid 315 into the ink flow path 490 is not particularly limited, but a supercritical fluid apparatus 300 manufactured by JASCO Corporation having a structure as shown in FIG. 5 may be suitably used. This apparatus 300 is provided with a carbon dioxide cylinder 302 for supplying carbon dioxide used as the first high pressure fluid, a high pressure container 310 for accommodating the laminated structure 400 and contacting it with a supercritical fluid 315, and a constant temperature bath 308 equipped with a thermometer 322 and a stirring device 311. Carbon dioxide supplied from the carbon dioxide cylinder 302 is cooled with a cooler 304, and is introduced into the high pressure container 310 in the constant temperature bath 308 while the pressure is controlled with a high pressure pump 306 equipped with a manometer 320 by opening a valve 324. In addition, the pressure in the high pressure container 310 may be controlled at a predetermined pressure with a back pressure adjuster 318. At adjustment of the back pressure, carbon dioxide, and various liquids discharged from the high pressure container 310 are recovered in a trap 312.

When supercritical carbon dioxide is supplied into the ink flow path 490 of the laminated structure 400 using the apparatus 300 having such a structure, first, the laminated structure 400 is placed into the high pressure container 310, and the container is closed. Then, the high pressure pump 306 and the valve 324 are adjusted to supply carbon dioxide having the purity of 99.99% or more into the high pressure container 310 and, at the same time, the cooler 304, the high pressure pump 306, and the constant temperature bath 308 are adjusted to set at the condition so that supercritical carbon dioxide 315 is generated in the high pressure container 310.

When supercritical carbon dioxide is selected as the high pressure fluid 315 as the present exemplary embodiment, the pressure in the high pressure container 310 is set to be 7.387 MPa which is the critical pressure of carbon dioxide, or higher, preferably in the range of 7.387 MPa or higher and 40.387 MPa or lower, more preferably in the range of 10 MPa or higher and 20 MPa or lower. The temperature in the high pressure container 310 is set to be 304.5 K which is the critical temperature of carbon dioxide, or higher, preferably in the range of 304.5 K or higher and 573.2 K or lower, more preferably 304.5 K or higher and 473.2 K or lower.

The treatment time may be determined depending on a material of resin layers 415, 465, and the target adhesive strength, and is usually appropriately set to be a time of around 0.001 second to a few months and, in the case of the laminated structure 400 for the inkjet recording head, it is treated, for example, for about 30 minutes. Supercritical carbon dioxide 315 in the high pressure container 310 may be stirred with a stirrer 314, if necessary.

Since supercritical carbon dioxide has also a property of a gas, it may easily enter a narrow space. For this reason, in the high pressure container 310, as shown in FIG. 4 (B), supercritical carbon dioxide 315 enters the ink flow path 490 of the laminated structure 400, and supercritical carbon dioxide 315 which has entered the ink flow path 490 is also supplied to resin layers 415, 465 which are exposed between members. By contact of supercritical carbon dioxide 315 with resins 415, 465 exposed in the flow path 490 of the laminated structure 400, and permeation of supercritical carbon dioxide therein, the crosslinking degree in resins 415, 465 is increased by the effect similar to that of uniform annealing, and the adhesive force is increased.

In this manner, when the high pressure fluid 315 such as supercritical carbon dioxide is contacted with resins 415, 465 to increase the crosslinking degree thereof, for example, many steps such as degassing in vacuum, heating of the adhesive, pressurizing, and cooling are not needed, and the adhesive strength may be easily improved. Alternatively, by directly pressurizing the laminated structure 400, leakage of the adhesive (resin) out of between members, and deformation of a member due to pressurizing may be suppressed.

[Removal Step of High Pressure Fluid]

After the laminated structure 400 is contacted with supercritical carbon dioxide (high pressure fluid) 315 for a predetermined time in the high pressure container 310, supercritical carbon dioxide 315 is removed from the ink flow path 490.

For example, when a pressure in the high pressure container 310 is gradually reduced with a back pressure adjuster 318 to return the pressure to the atmospheric pressure, supercritical carbon dioxide 315 is changed into a gas, and supercritical carbon dioxide 315 is removed also from the ink flow path 490. Thereupon, when the pressure reducing rate is too high, supercritical carbon dioxide which has permeated in resins 415, 465 is rapidly changed into a gas to expand, and there is a possibility that the adhesive strength is reduced occasionally. For this reason, by optimizing a step of reducing the pressure of the supercritical fluid, the adhesive strength may be increased more, and the pressure reducing rate is preferably 1.0 MPa/sec or lower, particularly preferably around 0.01 MPa/sec.

Upon removal of supercritical carbon dioxide, by repeating increase and decrease of the pressure or the temperature to change the state between the supercritical fluid and the gas, the cleaning effect may be also exerted. For example, initially, the pressure in the high pressure container 310 is slowly lowered to the critical point or lower to change the supercritical fluid into the gas, whereby the adhesive strength of a resin is assuredly increased, thereafter, the pressure is increased again to the critical point or higher to change the gas into the supercritical fluid, and then, a pressure is rapidly reduced to change the supercritical fluid into the gas. Alternatively, increase and decrease of the temperature may be repeated to change the state between the supercritical fluid and the liquid. Since the supercritical fluid is rapidly vaporized or liquidized by increase and decrease of the pressure or the temperature in this manner, the fluid is furiously flown also in the ink flow path 490 of the laminated structure 400, and a foreign matter and the like adhered to an inner wall 422 of the flow path 490 may be effectively removed. However, when the pressure reducing rate is too great also upon obtaining of the cleaning effect by increase and decrease of the pressure in the high pressure container 310, since an adhesive joint may be destructed, the pressure reducing rate is preferably 1.0 MPa/sec or less, particularly preferably around 0.01 MPa/sec.

For example, compressed carbon dioxide in the carbon dioxide cylinder is supplied to the pressure container 310 with a liquid supplying pump at the rate of 1 ml/min and, at the same time, the pressure is controlled with the back pressure adjuster 318 provided in an outlet side of the pressure container 310. By doing so, treatment (increase in crosslinking degree) of adhesive layers 415, 465 with supercritical carbon dioxide 315 is performed in the pressure container 310 at the pressure of 15 MPa and the temperature of 50° C. for 30 minutes. After treatment with supercritical carbon dioxide 315, the pressure may be slowly reduced manually by 0.01 to 0.03 MPa/s so that rapid pressure change is not caused.

[Plating Step]

Then, a plating film 423 is formed on the inner wall 422 of the ink flow path 490 with a mixed fluid 317 obtained by mixing and stirring a second high pressure fluid and a plating solution. For example, via cleaning, plating pretreatment (degreasing, pickling, surface adjustment, activation treatment, and cleaning between these steps), plating, cleaning, and drying, the plating film 423 may be formed in the ink flow path.

—Plating Pretreatment Step—

Since the plating pretreatment is different depending on a plating method selected in the plating step (electroplating method or electroless plating method) and a material of the laminated structure 400, the method may be appropriately selected.

Examples of the plating pretreatment include degreasing, pickling, surface adjustment, and activation treatment (formation of a plating pretreatment layer), and cleaning. It is preferable that cleaning is appropriately performed without being limited to plating pretreatment, and it is particularly preferable that cleaning is performed before at least one step of a degreasing step (FIG. 3 (C)), a pickling and surface adjusting step (FIG. 3 (D)), a plating step (FIG. 3 (F)), and a drying step (FIG. 3 (G)).

As described above, in the invention, the crosslinking degree of crosslinking resin layers 415, 465 is increased with the high pressure fluid to increase the adhesive strength, and the high pressure fluid may be suitably used in any step of the degreasing step, the pickling and surface adjusting step, the plating step, the drying step, and the cleaning step. It is particularly preferable that, before the plating step, a step of degreasing with the high pressure fluid, and a step of performing pickling and surface adjustment with the high pressure fluid containing an acid are conducted.

The high pressure fluid used in the crosslinking degree increasing step (first high pressure fluid), the high pressure fluid used in the plating step (second high pressure fluid), the high pressure fluid used in the degreasing step (third high pressure fluid), the high pressure fluid used in the step of performing pickling and surface adjustment with the high pressure fluid containing an acid (fourth high pressure fluid), and the high pressure fluid used in the cleaning step (fifth high pressure fluid) may be different kinds, respectively, but it is preferable to use the same kind, particularly, supercritical carbon dioxide. For example, as the first high pressure fluid used in the crosslinking degree increasing step, supercritical carbon dioxide is used and, as the second, third, fourth, and fifth high pressure fluids, carbon dioxide, a mixed fluid of carbon dioxide and a surfactant, a mixed fluid of carbon dioxide, water and a surfactant, a mixed fluid of carbon dioxide, water, a surfactant and an acid, or a mixed fluid of carbon dioxide, water, a surfactant and alkali may be suitably used.

—Degreasing—

In order to remove an oil component adhered in, particularly, the ink flow path 490 of the laminated structure 400, degreasing is performed. A subject to be plated (laminated structure 400) may be degreasing-cleaned in advance as usual, but when a solvent such as trichloroethylene, tetrachloroethylene, or trichloroethane is used upon a degreasing operation, this may cause adverse influence on the environment.

On the other hand, when any of the high pressure fluid such as supercritical carbon dioxide alone, the high pressure fluid+the surfactant, the high pressure fluid+the surfactant+water, the high pressure fluid+water, the high pressure fluid+the surfactant+the acidic solution, or the high pressure fluid+the surfactant+the alkaline solution is used, the interior of the ink flow path 490 of the laminated structure 400 is naturally degreased-cleaned due to a stream generated in the system, during a process of increasing the temperature and the pressure to bring about the supercritical state or the sub-critical state. Therefore, in the invention, a degreasing operation using an organic degreasing agent before the plating step as usual may be omitted, and an environmental preservation-type system may be also realized.

The degreasing treatment (FIG. 3 (C)) is for the purpose of removing an oily stain on a surface of a material to be plated, such as, for example, a fat or oil, a processing oil, an anti-rust oil, a resin, or a fingerprint, by an abrading treatment, but when degreasing is also performed sufficiently by supply of the high pressure fluid (FIG. 3 (A)) and removal of the high pressure fluid (FIG. 3 (B)), the degreasing step of FIG. 3 (C) may be omitted.

—Pickling and Surface Adjustment—

It is preferable that, after degreasing, the inner wall 422 of the ink flow path 490 is subjected to pickling and surface adjustment with a high pressure fluid containing an acid. In this manner, by pickling and surface adjustment using the high pressure fluid containing an acid, an oxidized film formed on the inner wall 422 of the ink flow path 490 of the laminated structure 400 may be removed and, by roughening a surface, adhesion of a plating film formed later may be improved. Particularly, when electroless plating is conducted in the plating step, catalyst particles are easily adhered by plating pretreatment due to the aforementioned pickling.

For example, a pickling solution with the surfactant added thereto, and carbon dioxide in the supercritical state or the sub-critical state as the high pressure fluid are mixed and stirred to be emulsified in a high pressure reaction container 310 of the supercritical fluid apparatus 300 having a structure as shown in FIG. 5. This emulsion surrounds the laminated structure 400, and reactant species are efficiently supplied to the laminated structure 400. Thereby, an oxide film in the ink flow path 490 of the laminated structure 400 may be removed and, at the same time, a surface may be uniformly roughened. In this manner, according to a method using the high pressure fluid containing an acid, since a smaller amount of a treating solution is required as compared with a previous method of immersing the laminated structure 400 in a pickling solution, an amount of a waste solution to be treated may be suppressed.

—Cleaning—

Cleaning using the high pressure fluid is preferable in that waste solution treatment such as generated in the conventional cleaning with a liquid such as a solvent is unnecessary. For example, while the laminated structure 400 is disposed in the high pressure reaction container 310, the interior of the container 310 is set at such a condition (temperature and pressure) so that the high pressure fluid (e.g. supercritical carbon dioxide) is generated, whereby the high pressure fluid is generated, and a foreign matter adhering to a surface of the laminated structure 400 or in the ink flow path 490 is removed utilizing high diffusivity and solubility of the high pressure fluid. Alternatively, by decreasing the pressure, or lowering the temperature in the container 310, since the high pressure fluid is rapidly vaporized or liquidized, the fluid is collided also against the inner wall 422 of the ink flow path 490 of the laminated structure 400 with a swift stream, whereby the inner wall may be effectively cleaned. In such a cleaning step, for example, any of the high pressure fluid such as supercritical carbon dioxide alone, the high pressure fluid+the surfactant, the high pressure fluid+water, the high pressure fluid+water+the surfactant, or the high pressure fluid+the surfactant+the acidic solution or the alkaline solution may be suitably used.

In this manner, by cleaning using the high pressure fluid, even in the laminated structure having a fine structure, a foreign matter (a remaining solvent of an adhesive) in the ink flow path may be removed without giving damage, adhesion of a plating film formed thereafter may be improved and, at the same time, the effect of preventing inclusion of the remaining substance into the ink is also obtained.

As described above, since any of a degreasing step, a step of performing pickling and surface adjustment with the high pressure fluid containing an acidic solution, and a cleaning step may be performed using the high pressure fluid including supercritical carbon dioxide, for example, using an apparatus 300 having a structure as shown in FIG. 5, carbon dioxide in the supercritical state or the sub-critical state may be circulated at the high speed to continuously conduct these steps. According to such a method, the high pressure fluid is moved at the high speed and smoothly without forming a Karman vortex, for example, as in the cleaning method of only introducing a degreasing fluid or a cleaning fluid into a plating bath, and is contacted with a body to be plated (laminated structure 400) at a constant rate, whereby degreasing and cleaning in the ink flow path 490 are also performed, and the high speed and precise cleaning action is maintained. For example, when the high pressure fluid is made to move parallel along the ink flow path 490 of the laminated structure 400, the high speed and precise cleaning action may be maintained without reducing the moving rate or the diffusion velocity.

—Formation Step of Plating Pretreatment Layer—

In order to form a plating film 423 in the ink flow path 490 of the laminated structure 400 by an electroless plating method, it is necessary to form a plating pretreatment layer on the inner wall 422 of the ink flow path 490 on which a plating film 423 is to be formed. This may be performed, for example, as follows.

First, a required amount of a predetermined surfactant is added to a palladium-based catalyst solution to adjust to a predetermined composition, and this catalyst solution and the high pressure fluid are stirred and emulsified in the reaction container. The solution stirred in the reaction container surrounds the laminated structure 400, whereby catalyst particles are uniformly contacted with the laminated structure 400, and also enter into the ink flow path 490. Thereby, a plating pretreatment layer with catalyst particles adhered thereto is formed on the inner wall 422 of the ink flow path 490 of the laminated structure 400. In addition, since catalyst particles are efficiently supplied to the laminated structure 400 by emulsification, the pretreatment layer may be formed with a very small amount as compared with the conventional method in which a subject is immersed in a catalyst solution.

On the other hand, when a plating film is formed in the ink flow path 490 of the laminated structure 400 made of a material having no electrical conductivity by an electroplating method, it is necessary that a seed layer having electrical conductivity as the plating pretreatment layer is formed in the ink flow path 490 of the laminated structure 400 on which a plating film is to be formed. In order to form such an electrically conductive seed layer, a dry process such as deposition, sputtering, CVD (Chemical Vapor Deposition), ALD (Atomic Layer Deposition), and CFD (Chemical Fluid Deposition) using the high pressure fluid, or a wet process such as usual electroless plating, and electroless plating using the high pressure fluid described later may be applied.

[Plating]

A plating step may be performed by an electroplating method or an electroless plating method. The case where supercritical carbon dioxide is used as the high pressure fluid, and a plating film is formed by an electroless plating method will be mainly explained below.

—Electroless Plating Step—

Electroless plating refers to a liquid phase thin film forming method of depositing a metal by an oxidation-reduction reaction using a solution containing a metal ion to be deposited as a plating film. When an electroless plating step is performed in the invention, a supercritical fluid apparatus 300 having a structure as shown in FIG. 5 may be used.

When the laminated structure 400 is subjected to electroless plating using the apparatus 300 having such a structure, first, an electroless plating solution, a stirrer 314 coated with TEFLON (registered trademark), and the laminated structure 400 which has been subjected to pre-treatment for electroless plating (FIG. 3 (C)) to (E)) are placed into the high pressure reaction container 310, and the container is closed. As the electroless plating solution, a plating solution obtained by adding a predetermined amount of a surfactant having a carbon dioxide-philic group (an affinity part for carbon dioxide) and a hydrophilic group to the following electroless plating solution, is used. The use amount of the surfactant is not particularly limited, but usually, the use amount is preferably around 0.0001 to 30 wt %, particularly preferably 0.001 to 10 wt % based on the electrolyte solution.

<Plating Solution>

As the plating solution, a plating solution depending on the purpose of a plating film to be formed, preferably, a plating solution further containing an additive such as a surfactant for promoting mixing with the high pressure fluid is used.

A metal matrix of a plating film is not particularly limited, and may be selected from metals such as nickel, copper, silver, zinc and tin, or alloys thereof. A plating film excellent in chemical resistance may be selected from metals such as rhodium, palladium, platinum, nickel, electroless nickel, chromium, tin, tin-lead, lead, silver, and copper, and alloys thereof. Particularly, electroless nickel is excellent in chemical resistance, and stain prevention.

As an electrolyte solution which is to be a plating solution, solutions in which one or more kinds of electrolytes such as metallic salts, organic electrolytes, acids such as phosphoric acid, and alkali substances are dissolved in a solvent are used.

The solvent is not particularly limited as far as it is a polar solvent, and examples include water, alcohols such as ethanol and methanol, cyclic carbonates such as ethylene carbonate, and propylene carbonate, straight carbonates such as dimethyl carbonate, ethyl methyl carbonate, and diethyl carbonate, and mixed solvents thereof.

The metal salts may be appropriately selected in view of the kind of a metal, an alloy, and an oxide to be deposited as the plating film. Examples of a metal which may be electrochemically deposited include Cu, Zn, Ga, As, Cr, Se, Mn, Fe, Co, Ni, Ag, Cd, In, Sn, Sb, Te, Ru, Rh, Pd, Au, Hg, Tl, Pb, Bi, W, Po, Re, Os, Ir, and Pt.

Examples of the organic electrolyte include anionic electrolytes such as polyacrylic acid, and cationic electrolytes such as polyethyleneimine, but are not limited thereto.

The electrolyte solution which is to be a plating solution may contain one or more kinds of substances, in addition to the aforementioned substances, for the purpose of stabilizing the solution. Specifically, examples include (1) a substance which forms a complex salt with an ion of a metal to be deposited, (2) an indifferent salt for improving electrical conductivity of the electrolyte solution, (3) a stabilizer for the electrolyte solution, (4) a buffer of the electrolyte solution, (5) a substance which changes the physical property of a deposited metal, (6) a substance which assists dissolution of a cathode, (7) a substance which changes the property of the electrolyte solution, or the property of a deposited metal, and (8) a stabilizer for a mixed solution containing two or more kinds of metals.

For example, when the composite plating film is formed by an electroless plating method, generally, an electroless plating solution containing metal salts, complexing agents, and reducing agents is used.

Examples of the metal which may be used in the electroless plating solution include V, Cr, Mo, W, Mn, Re, Fe, Ru, Co, Rh, Ni, Pd, Pt, Cu, Ag, Au, Cd, B, In, Ti, Sn, Pb, P, As, Sb, and Bi.

Examples of the complexing agent include organic acids such as dicarboxylic acids such as succinic acid, oxycarboxylic acids such as citric acid and tartaric acid, and aminoacetic acids such as glycine and EDTA, and sodium salts thereof.

Examples of the reducing agent include sodium hypophosphite, sodium phosphite, formaldehyde, sodium borohydride, potassium borohydride, dimethylamineborane, and hydrazine.

Whether an electroplating solution or an electroless plating solution, in the case of plating treatment using supercritical CO₂, since supercritical CO₂ is dissolved in the plating solution, and the pH of the plating solution is sifted to an acidic side, it is preferable to use a plating solution having a high degree of bath stability in an acidic region.

<Surfactant>

A non-polar high pressure fluid such as supercritical carbon dioxide is immiscible with the aforementioned plating solution, and the plating solution is separated from supercritical carbon dioxide. Then, by adding a surfactant, the plating solution is emulsified to be uniform, whereby the reaction efficiency may be improved. As the surfactant, from anionic, nonionic, cationic and amphoteric surfactants which have been previously used, at least one kind may be selected and used. In a combination of the high pressure fluid of a polar substance such as supercritical water and the plating solution of a polar substance, since there is miscibility, it is not necessary to add the surfactant.

Examples of the anionic surfactant are not limited to, but include soap, alphaolefinsulfonate, alkylbenzenesulfonate, alkylsulfate, alkylether sulfate, phenylether sulfate, salt of methyl taurine acid, sulfosuccinate, ethersulfonate, sulfonated oil, phosphate, perfluoroolefinsulfonate, perfluoroalkylbenzenesulfonate, perfluoroalkylsulfate, perfluoroalkylethersulfate, perfluorophenylethersulfate, salt of perfluoromethyl taurine acid, sulfoperfluorosuccinate, and perfluoroethersulfonate.

Examples of a cation of a salt of the anionic surfactant are not limited to, but include sodium, potassium, calcium, tetraethylammonium, triethylmethylammonium, diethyldimethylammonium, and tetramethylammonium, and cations capable of being electrolyzed may be used.

Examples of the nonionic surfactant are not limited to, but include C1-25 alkylphenol system, C1-20 alkanol, polyalkylene glycol system, alkylolamide system, C1-22 fatty acid ester system, C-22 aliphatic amine, alkylamine ethylene oxide adduct, arylalkylphenol, C1-25 alkylnaphthol, C1-25 alkoxylated phosphoric acid (salt), sorbitan ester, styrenated phenol, alkylamine ethylene oxide/propylene oxide adduct, alkylamine oxide, C1-25 alkoxylated phosphoric acid (salt), perfluorononylphenol system, perfluoro higher alcohol system, perfluoropolyalkylene glycol system, perfluoroalkylolamide system, perfluorofatty acid ester system, perfluoroalkylamine ethylene oxide adduct, perfluoroalkylamine ethylene oxide/perfluoropropylene oxide adduct, and perfluoroalkylamine oxide.

Examples of the cationic surfactant are not limited to, but include lauryltrimethylammonium salt, stearyltrimethylammonium salt, lauryldimethylethylammonium salt, dimethylbenzyllaurylammonium salt, cetyldimethylbenzylammonium salt, octadecyldimethylammonium salt, trimethylbenzylammonium salt, hexadecylpyridinium salt, laurylpyridinium salt, dodecylpicolinium salt, stearylamineacetate, laurylamineacetate, octadecylamineacetate, monoalkylammonium chloride, dialkylammonium chloride, ethylene oxide adduct-type ammonium chloride, alkylbenzylammonium chloride, tetramethylammonium chloride, trimethylphenylammonium chloride, tetrabutylammonium chloride, acetic acid monoalkylammonium, imidazoliniumbetaine system, alanine system, alkylbetaine system, monoperfluoroalkylammonium chloride, diperfluoroalkylammonium chloride, perfluoroethylene oxide adduct-type ammonium chloride, perfluoroalkylbenzylammonium chloride, tetraperfluoromethylammonium chloride, triperfluoromethylphenylammonium chloride, tetraperfluorobutylammonium chloride, acetic acid monoperfluoroalkylammonium, and perfluoroalkylbetaine system.

Examples of the amphoteric surfactant include betaine, sulfobetaine, and aminocarboxylic acid, as well as sulfated or sulfonated adduct of a condensation product of ethylene oxide and/or propylene oxide with alkylamine or diamine, being not limiting.

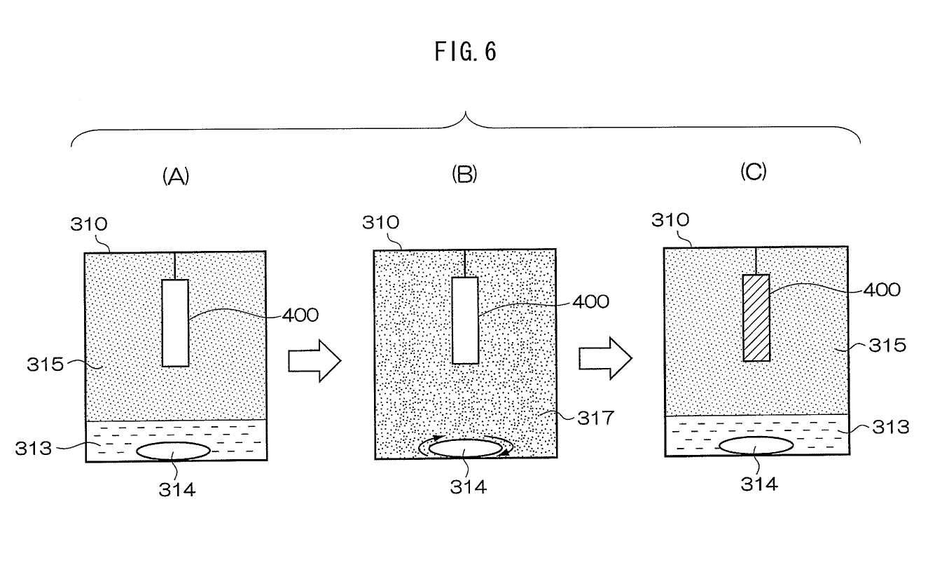

After putting the plating solution into the high pressure container 310, carbon dioxide having the purity of 99.99% or more is introduced into the high pressure reaction container 310 by means of the high pressure pump 306. Thereupon, as shown in FIG. 6 (A), the electroless plating solution 313 and supercritical carbon dioxide 315a are still in the separated state.

After carbon dioxide is introduced into the high pressure reaction container 310, a stirring device 311 is driven to rotate the stirrer 314. The pressure in the reaction container 310 at that time is 7.387 MPa which is the critical pressure of carbon dioxide, or higher, and is set in the range of preferably 7.387 MPa or higher and 40.387 MPa or lower, more preferably 10 MPa or higher and 20 MPa or lower. And, the reaction temperature is 304.5 K which is the critical temperature of carbon dioxide, or higher, and is set in the range of preferably 304.5 K or higher and 573.2 K or lower, more preferably 304.5 K or higher, and 473.2 K or lower. And, the reaction time may be determined depending on the target thickness of the plating film, and usually is appropriately set at the time of about 0.001 second to a few months.

As shown in FIG. 6 (B), in the reaction container 310, supercritical carbon dioxide 315, and the electroless plating solution 313 with the surfactant added thereto are stirred with the stirrer 314, and the system is brought into the state where the laminated structure 400 is covered with the emulsified mixed fluid 317. That is, by mixing the plating solution containing the surfactant, and the high pressure fluid having the low viscosity and the high diffusion constant by stirring to be emulsified, a bath is homogenized. Thereby, as shown in FIG. 4 (C), the mixed fluid 317 enters the fine and complicated ink flow path 490 of the laminated structure 400, and plating metal ions are uniformly supplied to the inner wall 422 of the flow path 490. And, after passage of a predetermined time, as shown in FIG. 4 (D), the conformal plating film 423 is formed on the inner wall 422 of the ink flow path 490.

Since hydrogen is generated in the plating reaction, usually, a pinhole and a void due to hydrogen are generated in the plating film, but in the invention, by using the high pressure fluid of carbon dioxide having high compatibility particularly with hydrogen, the hydrogen may be instantly removed, and occurrence of a pinhole and a void may be suppressed.

In addition, in the conventional electroless plating, when palladium fine particles are adhered to the nozzle plate 11 as pretreatment, and electroless plating is performed, the plating film is grown first at the surrounding of the palladium fine particles, the surface roughness is increased with increase in the plating time, and a nodule is easily generated, but in the plating method using the high pressure fluid according to the invention, influence of the plating pretreatment step influencing on the aforementioned surface roughness of the plating film and formation of a nodule is reduced. For this reason, smoothness of the plating film surface is improved, and occurrence of a nodule is also suppressed.

The charging ratio of the high pressure fluid and the electrolyte solution in a bath is not particularly limited, but may be appropriately set in view of the concentration of the electrolyte solution, the reaction conditions and so on. However, since when an amount of the electrolyte solution is too small, the reaction becomes difficult to proceed, it is preferable that at least 0.01 wt % or more of the electrolyte solution is contained based on the high pressure fluid at the critical point or lower.

In addition, as an embodiment, for example, when an electroless Ni—P plating film having a thickness of around 1 μm is formed on a whole surface of a 2.0 cm² copper substrate, 30 ml of an electroless Ni—P plating solution, and a surfactant at 0.1 wt % based on the plating solution are added to a 50 ml batch-manner high pressure reactor, supercritical carbon dioxide is introduced into the remaining volume in the reactor, and the mixture is stirred, whereby a plating film may be formed on the copper substrate.

After a predetermined reaction time, stirring is stopped, and the pressure in the reaction container 310 is lowered to the atmospheric pressure. Thereupon, as shown in FIG. 6 (C), the reaction is separated into carbon dioxide 315 and the electroless plating solution 313 again.

Then, the laminated structure 400 is taken out from the reaction container 310, and cleaned. It is preferable to remove the electroless plating solution remaining on a surface of the laminated structure 400 using the high pressure fluid (supercritical carbon dioxide etc.) as in the aforementioned cleaning step, also in this cleaning.

In the plating step, fine particles having properties to be imparted to the plating film are added to the plating solution to form a composite plating film. For example, when the plating solution to which a predetermined amount of fine particles, a representative of which is a fluorine-containing resin fine particle, are added, and the high pressure fluid such as supercritical carbon dioxide are stirred and mixed, and the laminated structure is subjected to plating, a water repellent composite plating film may be formed on the inner wall 422 of the ink flow path 490.

Alternatively, the formed plating film may be subjected to water repellent treatment and hydrophilization treatment depending on the use. For example, when the plating film formed in the flow path is subjected to hydrophilization treatment, there is a method of flowing a dry oxygen gas containing ozone in the flow path, and treating at the temperature of 100 to 300° C. (heating oxidizing treatment).

[Drying]

After the plating step, the laminated structure is cleaned, and then is dried. When the protective film for plating is provided on a surface of the laminated structure 400 before the plating step, the protective film is removed from the laminated structure 400, and then the structure is cleaned.

Also in a step of drying the plating film after the plating step, it is preferable that the interior of the ink flow path 490 of the laminated structure 400 is cleaned with the high pressure fluid such as supercritical carbon dioxide, and then dried. Alternatively, after the laminated structure 400 is cleaned and dried, the protective film may be removed.

As described above, by using the high pressure fluid, the adhesive strength of resin layers 415, 465 is enhanced, and the inkjet recording head 400 in which the conformal plating film 423 is formed in the ink flow path 490 as shown in FIG. 4 (D) may be obtained.

Since the plating film 423 is continuously formed on the inner wall 422 of the ink flow path 490, an adhesive joint is also protected with the plating film 423, and the adhesive strength may be further improved. In addition, due to possession of ink resistance by the plating film 423, selectivity of the head member is widened.

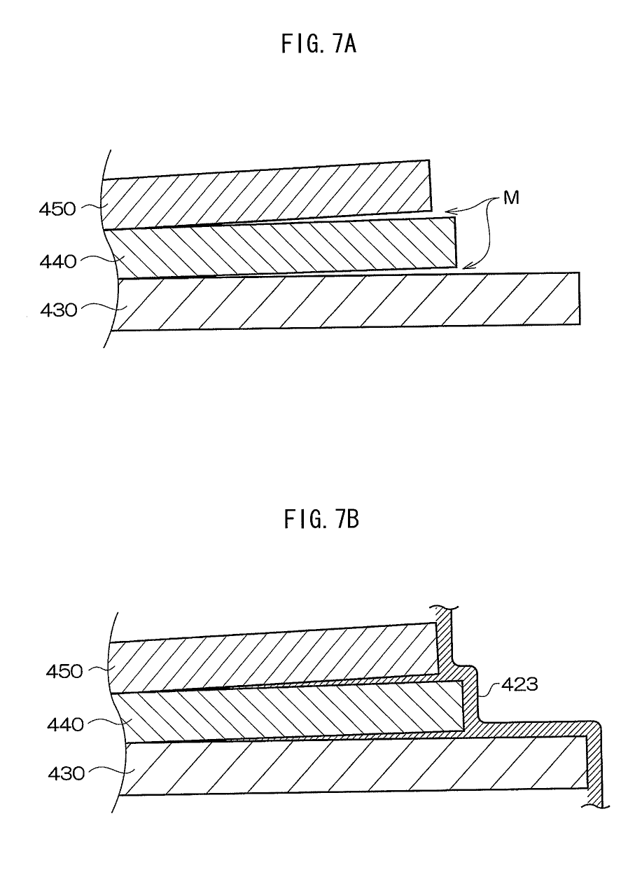

In addition, for example, as shown in FIG. 7A, even when a small gap M is present between members 430, 440, 450 laminated in the ink flow path 490, the gap part M is covered with the plating film 423 to smooth the inner wall as shown in FIG. 7B. Thereby, the strength of the inkjet recording head 400 may be further improved and, at the same time, pressure leakage at the time of jetting ink may be reduced.

In addition, by using the high pressure fluid, particularly, the high pressure fluid of carbon dioxide having high compatibility with hydrogen, an extremely smooth plating film in which occurrence of a pinhole, a void, and a nodule being a problem in the conventional plating method is reduced, may be formed. Particularly, when plating is performed by the electroless plating method using the high pressure fluid, influence on a surface condition (surface roughness etc.) of the plating film due to the plating pretreatment step may be reduced.

In addition, by performing plating by stirring and mixing the high pressure fluid and the plating solution, the conformal plating film may be formed in an internal structure (ink flow path) of a fine and complicated inkjet head and, if necessary, also on an external structure thereof. By forming the plating film in the ink flow path, the inner wall is flattened, and pressure leakage at the time of jetting ink may be also reduced.

In this manner, in the invention, by using the high pressure fluid, improvement in the adhesive strength of the resin layer, and formation of the plating film in the ink flow path may be continuously performed. In addition, in the inkjet recording head manufactured by the invention, the adhesive strength of the adhesive layer in the ink flow path is improved as compared with the conventional one and, further, by forming the plating film using the high pressure fluid and the plating solution, ink resistance is further improved, and jetting stability is also remarkably improved.

The invention is explained as described above, but the invention is not limited to the aforementioned exemplary embodiments.

The laminated structure is not limited to the laminated structure for the inkjet recording head, but may be suitably applied to plating of a microdevice and the like. Specifically, the laminated structure is used as the means for moving a fluid in microchemistry which is being developed in many fields such as medical science, pharmaceutical science, biology, and technology. For example, the invention may be also suitably applied to manufacturing of microreactors, biosensors, analysis equipments, capillary columns and filtration filters.

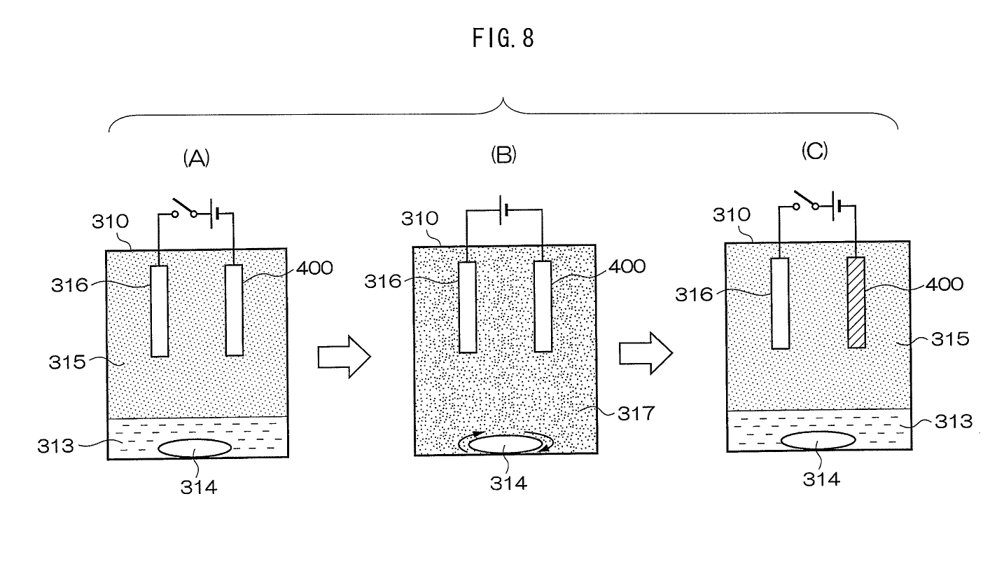

In addition, for example, when the plating film is formed by electroplating, as shown in FIG. 8 (A), an aqueous solution (plating solution) 313 containing a salt including a metal constituting the plating film, and a surfactant is put into the reaction container 310, and the laminated structure 400 is set to be a cathode, and a metal which is to be a metal matrix of the plating film or an insoluble electrode (graphite etc.) is set to be an anode 316. Then, for example, supercritical carbon dioxide as the high pressure fluid 315 is introduced into the reaction container 310, and the mixture is stirred by rotating the stirrer 314 (FIG. 8 (B)). And, by connecting both electrodes to the direct current, and performing electrolysis at the low current, the plating film may be formed in the ink flow path of the laminated structure 400 (FIG. 8 (C)).

In addition, since each step may be performed using the high pressure fluid including supercritical carbon dioxide from the crosslinking degree increasing step to the drying step after the plating step (FIG. 3 (A) to (G)), by closed system equipped with the supercritical fluid apparatus 300 as shown in FIG. 5, waste liquid treatment may be reduced, and improvement in the adhesive strength and formation of the plating film may be performed at the low cost.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A process for manufacturing a laminated structure comprising:
providing a laminated structure in which a plurality of members are laminated via a crosslinking resin at a part thereof,
supplying a high pressure fluid to a part of the laminated structure on which the crosslinking resin is exposed, thereby, increasing the crosslinking degree of the crosslinking resin, and
removing the high pressure fluid from the laminated structure.

2. A process for manufacturing an inkjet recording head comprising:
providing a laminated structure for an inkjet recording head having an ink flow path, in which a plurality of members are laminated via a crosslinking resin at a part thereof,
supplying a first high pressure fluid to the ink flow path of the laminated structure, thereby, increasing the crosslinking degree of the crosslinking resin which is exposed in the ink flow path,
removing the first high pressure fluid from the ink flow path, and
forming a plating film on an inner wall in the ink flow path with a mixed fluid obtained by mixing and stirring a second high pressure fluid and a plating solution, after the high pressure fluid removal.

3. The process for manufacturing an inkjet recording head of claim 2, wherein in the high pressure fluid removal, the high pressure fluid is removed at a pressure reducing rate of 1.0 MPa/sec or lower.

4. The process for manufacturing an inkjet recording head of claim 2, wherein the plating is performed by an electroplating method or an electroless plating method.

5. The process for manufacturing an inkjet recording head of claim 2, wherein before the plating, degreasing with a third high pressure fluid, and pickling and surface adjustment with a fourth high pressure fluid containing an acid are performed.

6. The process for manufacturing an inkjet recording head of claim 2, wherein drying is performed after the plating.

7. The process for manufacturing an inkjet recording head of claim 5, wherein drying is performed after the plating.

8. The process for manufacturing an inkjet recording head of claim 7, wherein cleaning with a fifth high pressure fluid is performed before at least one of the degreasing, the pickling and surface adjustment, the plating, or the drying.

9. The process for manufacturing an inkjet recording head of claim 8, wherein the first, second, third, fourth and fifth high pressure fluids comprise a supercritical fluid of carbon dioxide.
